(19) United States
(12) Patent Application Publication
(10) Pub. No.: US 2018/0115873 A1
(43) Pub. Date: Apr. 26, 2018

(54) APPARATUS AND METHOD FOR PROXIMITY-BASED SERVICE COMMUNICATION

(71) Applicant: NEC Corporation, Tokyo (JP)

(72) Inventor: Hiroaki AMINAKA, Tokyo (JP)

(73) Assignee: NEC Corporation, Tokyo (JP)

(21) Appl. No.: 15/559,330

(22) PCT Filed: Nov. 30, 2015
(86) PCT No.: PCT/JP2015/005937

§ 371 Date: Sep. 18, 2017

(30) Foreign Application Priority Data
Mar. 19, 2015 (JP) 2015-055596

(51) Int. Cl. H04W 4/029; H04W 72/12; H04W 72/04; H04W 4/80; H04W 8/00; H04W 72/02

(52) U.S. Cl. CPC H04W 4/029; H04W 72/1263; H04W 72/02; H04W 4/80; H04W 8/005; H04W 72/0406

(57) ABSTRACT

A radio terminal apparatus (1) transmits, to a radio access network (3), resource information indicating a first radio resource to be used for sidelink communication (103), an effective period or effective number of times of the first radio resource, or both the first radio resource and the effective period or effective number of times. The sidelink communication (103) includes at least one of direct discovery and direct communication performed between the radio terminal apparatus (1) and another radio terminal (2). It is thus, for example, possible to contribute to avoidance of conflict between a radio resource for a sidelink communication and a radio resource for an intra-cell uplink transmission, intra-cell downlink transmission, or another sidelink communication.

### TECHNICAL FIELD

The present application relates to Proximity-based services (ProSe) and, in particular, to direct discovery and direct communication that are performed by using a direct interface between radio terminals.

### TECHNICAL FIELD

The 3GPP Release 12 specifies Proximity-based services (ProSe) (see, for example, Non-patent Literature 1). ProSe includes ProSe discovery and ProSe direct communication. ProSe discovery makes it possible to detect proximity of radio terminals. ProSe discovery includes direct discovery (ProSe Direct Discovery) and network-level discovery (EPC-level ProSe Discovery).

ProSe Direct Discovery is performed through a procedure in which a radio terminal capable of performing ProSe (i.e., ProSe-enabled UE) detects another ProSe-enabled UE by using only the capability of a radio communication technology (e.g., Evolved Universal Terrestrial Radio Access (E-UTRA) technology) possessed by these UEs. On the other hand, in EPC-level ProSe Discovery, a core network (i.e., Evolved Packet Core (EPC)) determines proximity of two ProSe-enabled UEs and notifies these UEs of detection of proximity, ProSe Direct Discovery may be performed by three or more ProSe-enabled UEs.

ProSe direct communication enables establishment of a communication path between two or more ProSe-enabled UEs existing in a direct communication range after the ProSe discovery procedure is performed. In other words, ProSe direct communication enables a ProSe-enabled UE to directly communicate with another ProSe-enabled UE, without communicating through a Public Land Mobile Network (PLMN) including a base station (eNodeB). ProSe direct communication may be performed by using a radio communication technology that is also used to access a base station (eNodeB) (i.e., E-UTRA technology) or by using a wireless local area network (WLAN) radio technology (i.e., IEEE 802.11 radio technology).

In 3GPP Release 12, a ProSe function communicates with a ProSe-enabled UE through a Public Land Mobile Network (PLMN) and assists ProSe discovery and ProSe direct communication. The ProSe function is a logical function that is used for PLMN-related operations required for ProSe. The functionality provided by the ProSe function includes, for example: (a) communication with third-party applications (a ProSe Application Server); (b) authentication of a UE for ProSe discovery and ProSe direct communication; (c) transmission of configuration information for ProSe discovery and ProSe direct communication (e.g., EPC-ProSe-User ID) to a UE; and (d) provision of network-level discovery (i.e., EPC-level ProSe discovery). The ProSe function may be implemented in one or more network nodes or entities. In this specification, one or more network nodes or entities that implement the ProSe function are referred to as a “ProSe function entity” or a “ProSe function server”.

As described above, ProSe direct discovery and ProSe direct communication are performed on an inter-UE direct interface. This direct interface is referred to as a PC5 interface or a sidelink. Hereinafter, in this specification, communication including at least one of direct discovery and direct communication is referred to as “sidelink communication”.

A UE needs to communicate with a ProSe function before performing sidelink communication (see Non-patent Literature 1). In order to perform ProSe direct communication and ProSe direct discovery, the UE has to communicate with the ProSe function and acquire authentication information by the PLMN from the ProSe function in advance. Further, in the case of ProSe direct discovery, the UE has to transmit a discovery request to the ProSe function. Specifically, when the UE desires transmission (announcement) of discovery information on the sidelink, the UE transmits to the ProSe function a discovery request for the announcement. On the other hand, when the UE desires reception (monitoring) of discovery information on the sidelink, the UE transmits to the ProSe function a discovery request for the monitoring. Then, when the discovery request has succeeded, the UE is permitted to transmit or receive the discovery information on the inter-UE direct interface (e.g., sidelink or PC5 interface).

The allocation of radio resources for the sidelink communication to n UE is performed by a radio access network (e.g., Evolved Universal Terrestrial Radio Access Network (E-UTRAN)) (see Non-patent Literatures 1 and 2). The UE which is permitted to perform the sidelink communication by the ProSe function performs ProSe direct discovery or ProSe direct communication by using radio resources configured by a radio access network node (e.g., eNodeB). In 3GPP ProSe, radio resources to be used for the sidelink transmission is limited to a subset of the uplink radio resources reserved for uplink transmissions in a cell (in E-UTRA). Sections 23.10 and 23.11 of Non-patent Literature 2 describe details of the allocation of radio resources for the sidelink communication to a UE.

Regarding ProSe direct communication, two resource allocation modes, i.e., Scheduled resource allocation and Autonomous resource selection are specified, in the Scheduled resource allocation for ProSe direct communication, a UE requests an eNodeB to allocate resources and the eNodeB schedules resources for sidelink control and data for the UE. Specifically, the UE sends to the eNodeB a scheduling request together with a ProSe Buffer Status Report (BSR).

On the other hand. In the Autonomous resource selection of ProSe direct communication, a UE autonomously selects resources for sidelink control and data from a resource pool(s). An eNodeB may allocate a resource pool(s) for the Autonomous resource selection to a UE in a System Information Block (SIB) 18. The eNodeB may allocate a resource pool for the Autonomous resource selection to a UE in Radio Resource Control (RRC)_CONNECTED via dedicated RRC signaling. This resource pool may be available when the U E is in RRC_IDLE.

Regarding ProSe direct discovery, two resource allocation modes, i.e., Scheduled resource allocation and Autonomous resource selection are also specified. In the Autonomous resource selection for ProSe direct discovery, a UE that desires transmission (announcement) of discovery information autonomously selects radio resources from a resource pool(s) for announcement. This resource pool is configured in UEs via broadcast (SIB 19) or dedicated signaling (RRC signaling).

In the Scheduled resource allocation for ProSe direct discovery, a UE requests an eNodeB to allocate resources for announcement via RRC signaling. The eNodeB allocates resources for announcement from a resource pool that is configured in UEs for monitoring. When the Scheduled resource allocation is used, the eNodeB indicates in SIB19 that it provides resources for monitoring of ProSe direct discovery but does not provide resources f o r announcement,

Furthermore, 3GPP Release 12 specifies a partial coverage scenario in which one UE is located out of the network coverage and the other UE is located in the network coverage (e.g., see Sections 4.4.3, 4.5.4 and 5.4.4 of Non-Patent Literature 1). In the partial coverage scenario, a UE that is out of coverage is referred to as a “remote UE” and a UE that is in coverage and acts as a relay between the remote UE and the network is referred to as a “ProSe UE-to-Network Relay”. The ProSe UE-to-Network Relay relays traffic (downlink and uplink) between the remote UE and the network (i.e., E-UTRAN and EPC). More specifically, the ProSe UE-to-Network Relay attaches to the network as a UE, establishes a PDN connection to communicate with a ProSe function entity or another Packet Data Network (PDN), and communicates with the ProSe function entity to start ProSe Direct Communication. The ProSe U E-to-Network Relay further performs the discovery procedure with the remote UE, communicates with the remote UE on the inter-UE direct interface (e.g., sidelink or PC5 interface), and relays traffic (downlink and uplink) between the remote UE and the network. When the Internet Protocol version 4 (IPv4) is used, the ProSe UE-to-Network Relay serves as a Dynamic Host Configuration Protocol Version 4 (DHCPv4) Server and Network Address Translation (NAT). When the IPv6 is used, the ProSe UE-to-Network Relay serves as a stateless DHCPv6 Relay Agent. In this specification, a radio terminal that has the ProSe function and the relay function such as the ProSe UE-to-Network Relay is herein referred to as a “relay radio terminal” or a “relay UE”. Further, a radio terminal that is served with the relay service by the relay radio terminal (relay UE) is hereinafter referred to as a “remote radio terminal” or a “remote UE”.

Note that 3GPP Release 12 ProSe is one example of proximity-based services (ProSe) that are provided based on geographic proximity of a plurality of radio terminals. Similarly to 3GPP Release 12 ProSe. the proximity-based service in a public land mobile network (PLMN) includes discovery and direct-communication phases assisted by a function or a node (e.g., ProSe function) located in the network. In the discovery phase, geographic proximity of radio terminals is determined or detected. In the direct communication phase, the radio terminals perform direct communication. The direct communication is performed between radio term trials in proximity to each other, without communicating through a public land mobile network (PLMN). The direct communication is also referred to as “device-to-device (D2D) communication” or “peer-to-peer communication”. In this specification, the term “ProSe” is not limited to 3GPP Release 12 ProSe and refers to proximity-based service communication including at least one of discovery and direct communication. Further, each of the terms “proximity-based service communication”, “ProSe communication”, and “sidelink communication” in this specification refers to at least one of the discovery and the direct communication.

The term “public land mobile network (PLMN)” in this specification indicates a wide-area radio infrastructure network, and means a multiple-access mobile communication system. The multiple-access mobile communication system enables mobile terminals to perform radio communication substantially simultaneously by sharing radio resources including at least one of time resources, frequency resources, and transmission power resources among the mobile terminals. Typical examples of multiple-access technology include Time Division Multiple Access (TDMA), Frequency Division Multiple Access (FDMA), Code Division Multiple Access (CDMA), Orthogonal Frequency Division Multiple Access (OFDMA), and any combination thereof. The public land mobile network includes a radio access network and a core network. Examples of the public land mobile network include a 3GPP Universal Mobile Telecommunications System (UMTS), a 3 GPP Evolved Packet System (EPS), a 3GPP2 CDMA2000 system, a Global System for Mobile communications (GSM (Registered Trademark))/General packet radio service (GPRS) system, a WiMAX system, and a mobile WiMAX system. The EPS includes a Long Term Evolution (LTE) system and an LTE-Advanced system.

### CITATION LIST

### Patent Literature

[Patent Literature 1] 3GPP TS 23.303 V12.3.0 (2014 December), “3rd Generation Partnership Project; Technical Specification Group Services and System Aspects; Proximity-based services (ProSe); Stage 2 (Release 12)”, December, 2014

[Patent Literature 2] 3GPP TS 36.300 V12.4.0 (2014 December), “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 12)”, December, 2014

### SUMMARY OF THE INVENTION

### Technical Problem

As described above, in 3GPP ProSe, radio resources to be used for the sidelink transmission is limited to a subset of the uplink radio resources reserved for intra-cell (intra-E-UTRA) uplink transmissions. In other words, a radio resource(s) to be used for the sidelink communication is selected from a subset of the uplink radio resources to be used for the uplink transmission from UEs to the eNodeB in the cell. In the Autonomous resource selection described above, the UE selects a radio resource for the sidelink communication from a resource pool. The resource pool is a subset of the uplink radio resources. Accordingly, a radio resource used in a sidelink communication may conflict with radio resources used in intra-cell uplink transmissions or with radio resources used in other sidelink communications.

For example, a radio resource used in sidelink communication of one UE may conflict with a radio resource used in uplink transmission from this UE to the eNodeB. When this type of conflict occurs, the UE preferentially performs the uplink transmission to the eNodeB and cannot perform the sidelink communication.

In another example, a radio resource used in sidelink communication of one UE may conflict with a radio resource used in uplink transmission of another UE. When this type of conflict occurs, the uplink communication and the sidelink communication may interfere with each other.

In another example, a radio resource used in one sidelink communication of one UE may conflict with a radio resource used in another sidelink communication of this UE. This situation may occur, for example, when the eNodeB allocates the same or a shared resource pool to these two sidelinks and the selection of a radio resource from the resource pool is performed by the communication counterpart UE (peer UE). When this type of conflict occurs, these two sidelink communications may interfere with each other.

In another example, a radio resource used in sidelink communication of one UE may conflict with a radio resource used in another sidelink communication performed by another UE. When this type of conflict occurs, these two sidelink communications may interfere with each other.

The radio resource may be, for example, a time resource, a frequency resource, or a time-frequency resource. To be more specific, the radio resource may include a time slot, a carrier frequency, a time-frequency resource element, a subframe, transmission power, or any combination thereof.

Further, 3GPP ProSe defines that the sidelink communication uses the uplink radio resources. However, another proximity-based service communication or future 3GPP ProSe may use a subset of the downlink radio resources reserved for intra-cell (intra E-UTRA) downlink transmissions. In this case, a radio resource used in a sidelink communication may conflict with radio resources used in intra-cell downlink transmissions or with radio resources used in other sidelink communications.

One of the objects to be attained by embodiments disclosed herein is to provide an apparatus, a method, and a program that contribute to avoidance of a conflict, between a radio resource for a sidelink communication and a radio resource for an intra-cell uplink transmission, intra-cell downlink transmission, or another sidelink communication.

### Solution to Problem

In a first aspect, a radio terminal apparatus includes at least one radio transceiver and at least one processor coupled to the at least one radio transceiver. The at least one processor is configured to transmit, to a radio access network, resource information indicating a first radio resource to be used for sidelink communication, an effective period or effective number of times of the first radio resource, or both the first radio resource and the effective period or effective number of times. The sidelink communication includes at least one of direct discovery and direct communication performed between the radio terminal apparatus and another radio terminal using the at least one radio transceiver.

In a second aspect, an entity that is located in a radio access network and controls radio resources in a cell includes a memory and at least one processor coupled to the memory. The at least one processor is configured to receive, from a first radio terminal, resource information indicating a first radio resource to be used for sidelink communication, an effective period or effective number of times of the first radio resource, of both the first radio resource and the effective period or effective number of times. The sidelink communication includes at least one of direct discovery and direct communication performed between the first radio terminal and a second radio terminal.

In a third aspect, a method performed by a radio terminal apparatus includes transmitting, to a radio access network, resource information indicating a first radio resource to be used for sidelink communication, an effective period or effective number of times of the first radio resource, or both the first radio resource and the effective period or effective number of times. The sidelink communication includes at least one of direct discovery and direct communication performed between the radio terminal apparatus and another radio terminal.

In a fourth aspect, a method performed by an entity that is located in a radio access network and controls radio resources in a cell includes receiving, from a first radio terminal, resource information indicating a first radio resource to be used for sidelink communication, an effective period or effective number of times of the first radio resource, or both the first radio resource and the effective period or effective number of times. The sidelink communication includes at least one of direct discovery and direct communication performed between the first radio terminal and a second radio terminal.

In a fifth aspect, a program includes instructions (software codes) that, when loaded into a computer, cause the computer to perform the method according to the aforementioned third or fourth aspect.

### Advantageous Effects of Invention

According to the aforementioned aspects, it is possible to provide an apparatus, a method, and a program that contribute to avoidance of a conflict between a radio resource for a sidelink communication and a radio resource for an intra-cell uplink transmission, intra-cell downlink transmission, or another sidelink communication.

### BRIEF DESCRIPTION OF DRAWINGS

FIG. 1 is a diagram showing a configuration example of a public land mobile network according to some embodiments;

FIG. 2 is a diagram showing a configuration example of the public land mobile network according to some embodiments;

FIG. 3 is a diagram showing a configuration example of the public land mobile network according to some embodiments;

FIG. 4 is a diagram showing a configuration example of the public land mobile network according to some embodiments;

FIG. 5 is a sequence diagram showing one example of a control procedure regarding sidelink communication according to a first embodiment;

FIG. 6 is a flowchart showing one example of operations of a radio access network node (eNodeB) according to a second embodiment;

FIG. 7 is a sequence diagram showing one example of a control procedure regarding sidelink communication according to the second embodiment;

FIG. 8 is a flowchart showing one example of operations of a radio access network node (eNodeB) according to a third embodiment;

FIG. 9 is a flowchart showing one example of operations of a radio access network node (eNodeB) according to a fourth embodiment;

FIG. 10 is a sequence diagram showing one example of a control procedure regarding sidelink communication according to the fourth embodiment;

FIG. 11 is a sequence diagram showing one example of a control procedure regarding sidelink communication according to a fifth embodiment;

FIG. 12 is a flowchart showing one example of operations of a radio access network node (eNodeB) according to the fifth embodiment;

FIG. 13 is a block diagram showing a configuration example of a radio access network node (eNodeB) according to some embodiments; and

FIG. 14 is a block diagram showing a configuration example of a radio terminal (UE) according to some embodiments.

### DESCRIPTION OF EMBODIMENTS

Specific embodiments are explained hereinafter in detail with reference to the drawings. In the drawings, the same or corresponding elements are denoted by the same reference signs, and repetitive descriptions will be avoided as necessary for clarity of explanation.

Embodiments described below will be explained mainly using specific examples with regard to an Evolved Packet System (EPS). However, these embodiments are not limited to being applied to the EPS and may also be applied to other mobile communication networks or systems such as a 3GPP (UMTS), a 3GPP2 CDMA2000 system, a GSM/GPRS system, and a WiMAX system.

### First Embodiment

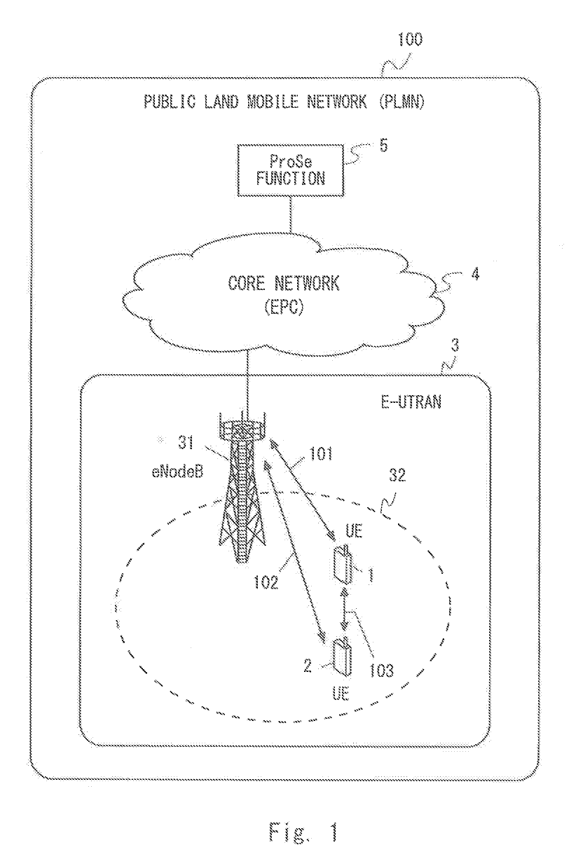

FIG. 1 shows a configuration example of a PLMN 100 according to this embodiment, UEs 1 and 2 are radio terminals capable of performing ProSe (i.e., ProSe-enabled UEs) and are able to perform sidelink communication on an inter-terminal direct interface (i.e., PC5 interface or sidelink) 103. The sidelink communication includes at least one of ProSe Direct Discovery and ProSe Direct Communication. The sidelink communication is performed by using a radio communication technology (E-UTRA technology) that is also used to access a base station (eNodeB) 31

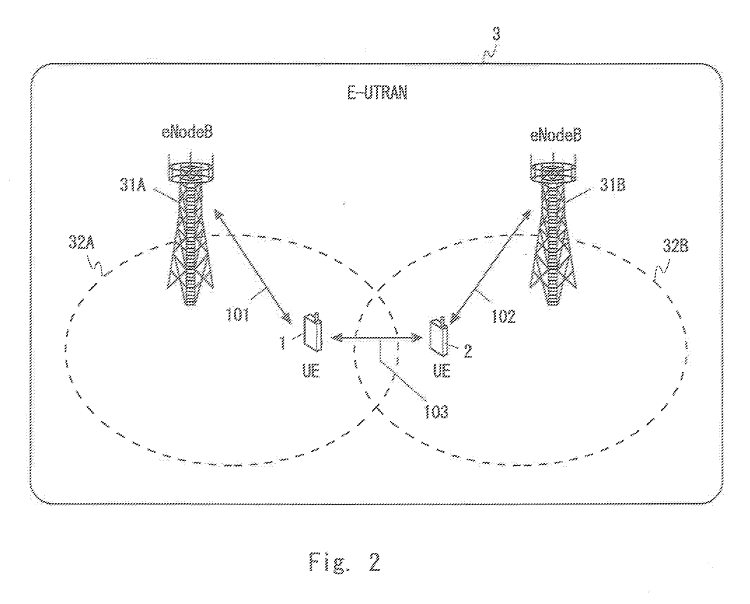

The eNodeB 31 is an entity located in a radio access network (i.e., E-UTRAN) 3, manages a cell 32, and is able to perform communication (101 and 102) with the UEs 1 and 2 by using the E-UTRA technology. While FIG. 1 shows a situation where both the UE 1 and 2 are located in the identical cell 32, such a UE arrangement is merely an example. For example, as shown in FIG. 2, the UE 1 may be located within one of adjacent cells managed by different eNodeBs 31 and the UE 2 may be located within the other one of the adjacent cells.

A core network (i.e., EPC) 4 includes a plurality of user plane entities (e.g., Serving Gateway (S-GW) and Packet Data Network Gateway (P-GW)) and a plurality of control plane entities (e.g., Mobility Management Entity (MME) and Home Subscriber Server (HSS)). The user plane entities relay user data of the UE 1 and 2 between the E-UTRAN 3 and an external network (Packet Data Network (PDN)). The control plane entities perform various kinds of control for the UEs 1 and 2 including mobility management, session management (bearer management), subscriber information management, and billing management.

In order to use a ProSe service (e.g., EPC-level ProSe Discovery, ProSe Direct Discovery, or ProSe Direct Communication), each of the UE 1 and the UE 2 attaches to the EPC 4 through the E-UTRAN 3, establishes a Packet Data Network (PDN) connection for communicating with a ProSe function entity 5, and transmits and receives ProSe control signaling to and from the ProSe function entity 5 through the E-UTRAN 3 and the EPC 4. The UE 1 2 may use EPC-level ProSe Discovery provided by the ProSe function entity 5. The UEs 1 and 2 may receive, from the ProSe function entity 5, a message indicating permission for the UEs 1 and 2 to activate (enable) ProSe Direct Discovery or ProSe Direct Communication. The UEs 1 and 2 may receive, from the ProSe function entity 5, configuration information for ProSe Direct Discovery or ProSe Direct Communication in the cell 32.

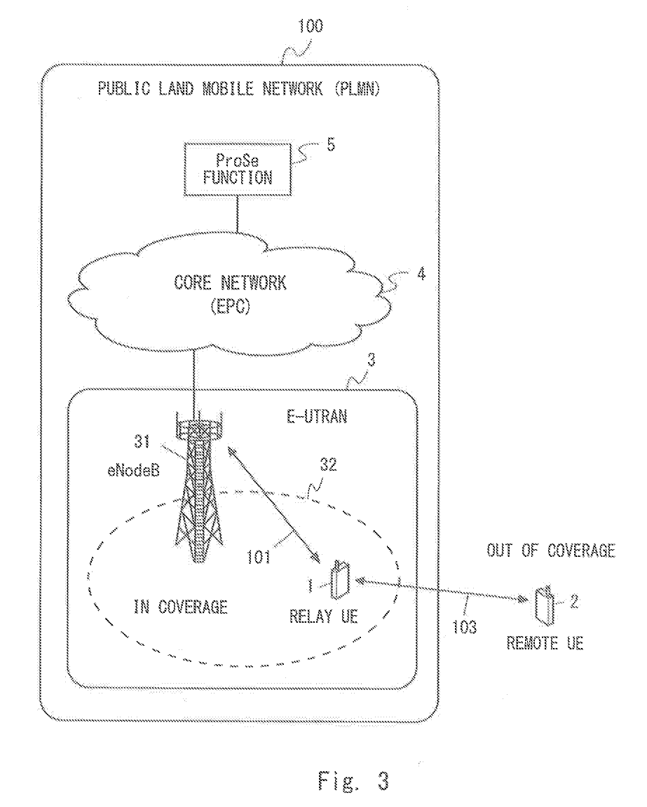

FIG. 3 shows another configuration example of the PLMN 100 according to this embodiment, i.e., a partial coverage scenario. In the example shown in FIG. 3, the UE 1 is located in the coverage of the E-URAN 3 (cell 32) and operates as a relay UE. On the other hand, the UE 2 is located out of coverage of the E-URAN 3 (cell 32) and operates as a remote UE.

In the example shown in FIG. 3, the relay UE 1 relays traffic (downlink and uplink) between the remote UE 2 and the PLMN 100 (i.e., E-UTRAN 3 and EPC 4). The remote UE 2 communicates with the ProSe function entity 5 or another PDN node via the direct interface (i.e., PC5 interface or sidelink) 103 with the relay UE 1. In the example shown in FIG. 1, the remote UE 2 is located out of the cell 32 of the eNodeB 31 (i.e., out-of-coverage). However, the remote UE 2 may be located within the cell 32 and be in a state of being unable to connect to the PLMN 100 due to any conditions (e.g., selection by the user). The remote UE 2 performs sidelink communication with the relay UE 1 when the remote UE 2 cannot connect to the PLMN 100 (e.g., out-of-coverage).

For the sake of convenience of explanation, the sidelink communication between the relay UE (e.g., the UE 1) and the remote UE (e.g., the UE 2) is ret erred to as the “sidelink communication in the partial coverage”. However, the “sidelink communication in the partial coverage” herein includes sidelink communication between the relay UE 1 that is in coverage and the remote UE 2 performed when the remote UE 2 is unable to connect to the PLMN 100 due to various factors. In this specification, the “sidelink communication in the partial coverage” may also be referred to as “ProSe UE-to-Network Relaying”

It may be determined that the remote UE 2 cannot connect to the PLMN 100 when the reception quality (e.g., Reference Signal Received Power (RSRP) or Reference Signal Received Quality (RSRQ)) of a radio signal transmitted from one of the eNodeBs 31 in the PLMN 100 is equal to or smaller than a predetermined threshold value. In other words, the remote UE 2 may determine that it cannot connect to the PLMN 100 in response to detecting that it has not successfully received the radio signal from the PLMN 100. Alternatively, the remote UE 2 may determine that it cannot connect to the PLMN 100 based on detecting that a connection to the PLMN 100 (e.g., attach to the EPC 4) has been rejected although it can receive radio signals from the eNodeB 31. Alternatively, the remote UE 2 may determine that it cannot connect to the PLMN 100 based on detecting that the remote UE 2 cannot normally communicate with the ProSe function entity 5 while it has been allowed to connect to the PLMN 100. Alternatively, the remote UE 2 may determine that it cannot connect to the PLMN 100 based on detecting that it has forcibly disconnected or deactivated its connection to the PLMN 100 according to an instruction from the user or from a control node in the PLMN 100 (e.g., ProSe function entity 5 or Operation Administration and Maintenance (OAM) server).

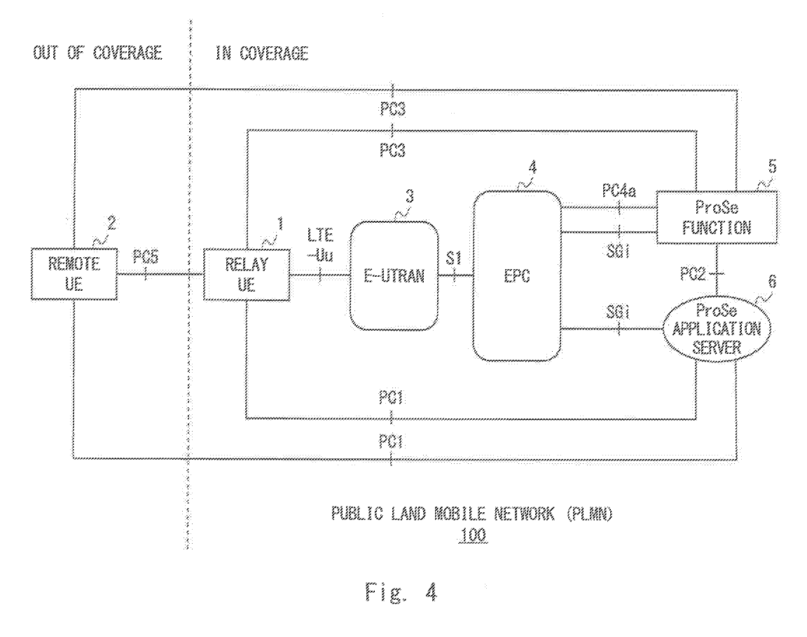

FIG. 4 shows reference points used in the sidelink communication and, in particular, shows reference points used in the sidelink communication in the partial coverage (ProSe UE-to-Network Relaying). Each reference point may be referred to as an interface. The reference points used in the intra-cell or inter-cell sidelink communication within the coverage shown in FIGS. 1 and 2 are the same as those shown in FIG. 4.

FIG. 4 shows a non-roaming architecture in which the relay UE 1 and the remote UE 2 use a subscription of the same PLMN 100. However, the Home PLMN (HPLMN) of the remote UE 2 may differ from the HPLMN of the relay UE 1. As one of the main applications of the sidelink communication in the partial coverage (ProSe UE-to-Network Relaying), a public safety usage is assumed. In the public safety usage, for example, the relay UE 1 in the PLMN 100 may perform sidelink communication with the remote UE 2 that does not have a subscription with the PLMN 100.

A PC1 reference point is a reference point between a ProSe application server 6 and a ProSe application in each of the relay UE 1 and the remote UE 2 and. The PC1 reference point is used to define application-level signaling requirements. The PC1 reference point depends on the user plane of the EPC 4 and, accordingly, communication between the ProSe application of the UE 1 and the ProSe application server 6 is transferred on the user plane of the EPC 4. Therefore, the ProSe application server 6 communicates with the EPC 4 (i.e., P-GW) through an SGi reference point.

A PC2 reference point is a reference point between the ProSe application server 6 and the ProSe function entity 5. The PC2 reference point is used to define interactions between the ProSe application server 6 and the ProSe functionality provided by the 3GPP EPS through the ProSe function entity 5.

A PC3 reference point is a reference point between each of the relay UE 1 and the remote UE 2 and the ProSe function entity 5. The PC3 reference point is used to define interactions between each UE relay UE 1 and remote UE 2) and the ProSe function entity 5 (e.g., UE registration, application registration, and authorization for ProSe Direct Discovery and EPC-level ProSe Discovery requests). The PC3 reference point depends on the user plane of the EPC 4 and, accordingly, ProSe control signaling between the UE 1 and the ProSe function entity 5 is transferred on the user plane of the EPC 4. Therefore, the ProSe function entity 5 communicates with the EPC 4 (i.e., P-GW) through an SGi reference point.

A PC4a reference point is a reference point between the ProSe function entity 5 and an HSS in the EPC 4. This reference point is used by the ProSe function entity 5, for example, to acquire subscriber information related to ProSe services.

As already described above, the PC5 reference point is a reference point between ProSe-enabled UEs and is used for the control plane and user plane of ProSe Direct Discovery, ProSe Direct Communication, and ProSe UE-to-Network Relay. The relay UE 1 and the remote UE 2 according to this embodiment perform sidelink communication including at least one of direct discovery and direct communication on the PC5 reference point.

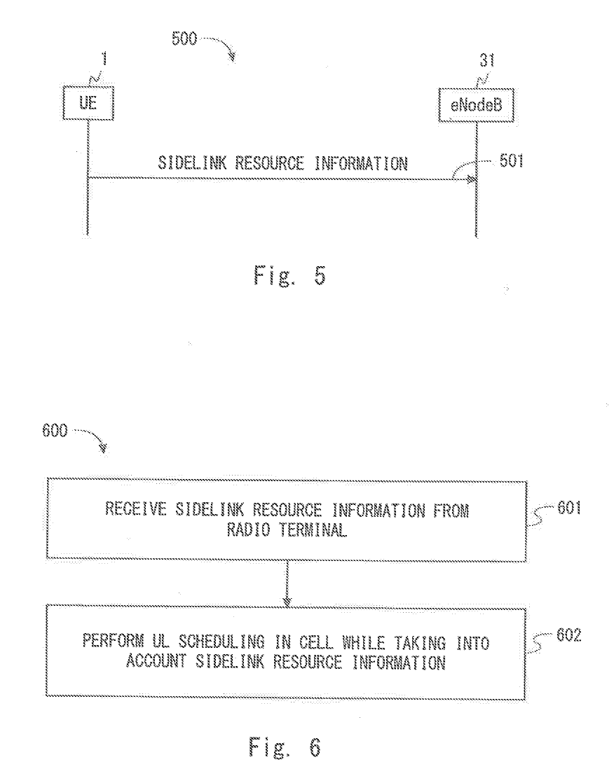

In the following description, a control procedure regarding the sidelink communication according to this embodiment will be described. FIG. 5 is a sequence diagram showing one example (Process 500) of a control procedure according to this embodiment, in Block 501, the UE 1 transmits sidelink resource information to the eNodeB 31 and the eNodeB 3 1 receives this information from the UE 1. This sidelink resource information indicates a first radio resource to be used for the sidelink communication (i.e., at least one of direct discovery and direct communication) between the UEs 1 and 2, an effective period or effective number of times of the first radio resource, or both the first radio resource and the effective period or effective number of times. The sidelink communication between the UEs 1 and 2 may be intra-cell or intra-base station sidelink communication within the coverage as shown in FIG. 1, inter-cell or inter-base station sidelink communication within the coverage as shown in FIG. 2, or may be sidelink communication in the partial coverage as shown in FIG. 3.

The first radio resource to be used for the sidelink communication between the UEs 1 and 2 may be a radio resource to be used for a sidelink transmission from the UE 1 to the UE 2, a radio resource to be used for a sidelink transmission from the UE 2 to the UE 1, or a radio resource shared for the bidirectional sidelink transmissions. The first radio resource may be, for example, a time resource, a frequency resource, or a time-frequency resource. To be more specific, the first radio resource may include a time slot, a carrier frequency, a time-frequency resource element (e.g., resource block), a subframe, transmission power, or any combination thereof.

The UE 1 and the UE 2 may be allowed to use the first radio resource only for the effective period. Alternatively, the UE 1 and the UE 2 may be allowed to use the first radio resource only the effective number of times. The effective period or effective number of times may be pre-configured in the UE 1 or the UE 2, may be sent to the UE 1 or the UE 2 from the ProSe function entity 5, or may be determined by the UE 1 or the UE 2.

As already described above, in 3GPP ProSe, radio resources to be used for the sidelink communication is limited to a subset of the uplink radio resources reserved for uplink transmissions. Accordingly, the first radio resource is contained in the subset included in the uplink radio resources.

In one example, the UE 1 may select the first radio resource from a resource pool(s) which is allocated by the E-UTRAN 3 (the eNodeB 31). In some implementations, the eNodeB 31 may provide a resource pool(s) to be used for the Autonomous resource selection of direct communication via System Information Block (SIB) 18. In this case, the UE 1 may autonomously select the first resource for direct communication from the resource pool(s) indicated in SIB 18. Further or alternatively, the UE 1 may receive a resource pool(s) to be used for the Autonomous resource selection of direct communication from the eNodeB 31 via dedicated RRC signaling. Further or alternatively, the eNodeB 31 may transmit a resource pool(s) to be used for the Autonomous resource selection of direct discovery via System Information Block (SIB) 19. In this case, the UE 1 may autonomously select the first resource for direct discovery from the resource pool(s) indicated in SIB 19. Further or alternatively, the UE 1 may receive a resource pool(s) to be used for the Autonomous resource selection of direct discovery using via dedicated RRC signaling.

In another example, the UE 1 may select the first radio resource from a resource pool(s) pre-configured in the UE 1. The pre-configured radio parameter(s) is stored in a built-in memory that is installed in the UE 1 or stored in a removable memory (e.g., Universal Integrated Circuit Card (UICC)) with which the UE 1 can communicate through an interface. The built-in memory or the removable memory is a volatile memory, a non-volatile memory, or a combination thereof. The volatile memory is, for example, a Static Random Access Memory (SRAM), a Dynamic RAM (DRAM), or a combination thereof. The non-volatile memory is, for example, a mask Read Only Memory (MROM), an Electrically Erasable Programmable ROM (EEPROM), a flash memory, a hard disc drive, or any combination thereof.

The UICC is a smart card used in a cellular communication system such as a GSM system, a UMTS, and an LTE system. The UICC includes a processor and a memory and executes a Subscriber Identity Module (SIM) application or a Universal Subscriber Identity Module (USIM) application for network authentication, in a strict sense, the UICC is different from the UIM, the SIM, and the USIM. However, these terms are often used synonymously. Accordingly, while the present application mainly employs the term UICC, the term UICC as used herein may mean the UIM, the SIM, the USIM or the like.

The eNodeB 31 can use the sidelink resource information received from the UE 1, which indicates the first radio resource, the effective period or effective number of times of the first radio resource, or both of them, for various purposes, in some implementations, the eNodeB 31 may use the sidelink resource information received from the UE 1 to suppress conflicts between the radio resource used in the sidelink communication between the UEs 1 and 2 and radio resource used in uplink transmissions in the cell 32. To be more specific, the eNodeB 3 1 may use the sidelink resource information received from the UE 1 when it performs resource scheduling (uplink scheduling) in the cell 32. These operations contribute to suppression of conflicts and interferences of radio resources between a sidelink communication and an uplink communication.

For example, the eNodeB 31 may avoid allocation of the first radio resource, which is used in the sidelink communication between the UEs 1 and 2, to an uplink transmission from the UE 1 to the eNodeB 31. Further or alternatively, the eNodeB 31 may avoid allocation of the first radio resource, which is used in the sidelink communication between the UEs 1 and 2, to an uplink transmission of a UE other than the UEs 1 and 2.

In some implementations, the eNodeB 31 may take into account the sidelink resource information received from the UE 1 when determining one or more radio resources to be allocated to another sidelink communication performed in the cell 32. For example, the eNodeB 31 may change the resource pool(s) for the other sidelink communication in the same cell 32 so as to exclude the first radio resource from this resource pool(s). The other sidelink communication in the same cell 32 may be a second sidelink communication performed by the UE 1 or may be a sidelink communication performed by a UE other than the UEs 1 and 2. These operation contribute to suppression of conflicts and interferences of radio resources between sidelink communications.

In some implementations, the eNodeB 31 (31A) may provide the sidelink resource information to the eNodeB 31 (31B) that manages the neighboring cell 32B. As a result of this, the neighboring eNodeB 31B can take into account the first radio resource, which is used in inter-cell (or inter-base station) sidelink communication, to perform uplink scheduling in the neighboring cell 32B and to perform radio resource allocation to sidelink communications in the neighboring cell 32B. Accordingly, it is possible to contribute to suppression of interference caused by sidelink communications in the cell 32A (or inter-cell sidelink communications or sidelink communications in the partial coverage) to uplink transmissions or sidelink communications in the neighboring cell 32B. At the same time, it is possible to contribute to suppression of interference caused by uplink transmissions or sidelink communications in the neighboring cell 32B to sidelink communications in the cell 32A.

In some implementations, the eNodeB 31 may update, based on the sidelink resource information, a radio configuration for the sidelink communication performed by the UE 1. For example, the eNodeB 31 may change the radio resource used in the sidelink communication by the UE 1 from the first radio resource to another radio resource. The eNodeB 31 may control the maximum transmission power of the sidelink communication performed by the UE 1. These operations contribute to maintenance or improvement of the communication quality of the sidelink communication performed by the UE 1.

As can be understood from the foregoing description, the UE 1 is configured to transmit the sidelink resource information to the eNodeB 31 and the eNodeB 31 is configured to receive this information from the UE 1. The sidelink resource information indicates either or both of the first radio resource to be used for sidelink communications (i.e., at least one of direct discovery and direct communication) between the UEs 1 and 2 and the effective period or effective number of times of the first radio resource. The sidelink resource information can be used for various purposes including, for example, suppression of resource conflict or interference between a sidelink communication and an uplink communication, and suppression of resource conflict or interference between one sidelink communication and another sidelink communication. Accordingly, the UE 1 and the eNodeB 31 according to this embodiment can contribute to avoidance of conflict on radio resources between a sidelink communication and an intra-cell uplink transmission, intra-cell downlink transmission, or another sidelink communication.

In this embodiment, the UE 1 may not always transmit the sidelink resource information to the eNodeB 31. For example, the frequent transmission of the sidelink resource information by the UE 1 may increase the load imposed on the UE 1 and the eNodeB 31. Accordingly, the UE 1 may be configured to transmit the sidelink resource information to the eNodeB 31 only when it performs a sidelink communication that needs special treatment. The sidelink communication that needs special treatment may be, for example, a sidelink communication in the partial coverage. This is because, when a radio resource for a sidelink communication with the UE 2 which is out of coverage conflicts with a radio resource for an uplink communication or another sidelink communication, it causes the U E 2 which is out of coverage, to be unable to perform communication.

To be more specific, the UE 1 may be configured to transmit the sidelink resource information to the eNodeB 31 when a predetermined condition is satisfied. The predetermined condition may include at least one of the following conditions (a) to (f):

(a) a condition regarding whether the UE 1 is located in the vicinity of the coverage boundary of the E-UTRAN 3 (e.g., cell edge of the cell 32),
(b) a condition regarding whether the UE 2 is out of coverage of the E-UTRAN 3,
(c) a condition regarding whether the UE 2 can be connected to the E-URAN 3,
(d) a condition regarding whether the UE 1 is transmitting a synchronization signal (e.g., Sidelink Synchronization Signal) to be detected by the UE 2,
(e) a condition regarding whether the UE 1 has been instructed by the E-UTRAN 3 (e.g., the eNodeB 31) to transmit the sidelink resource information, and
(f) a condition regarding whether the UE 1 performs sidelink communication with the UE 2.

Regarding the condition (a), the UE 1 may transmit the sidelink resource information when the UE 1 is located in the vicinity of the coverage boundary of the E-UTRAN 3 (e.g., cell edge of the cell 32). When the UE 1 is in the coverage boundary of the E-UTRAN 3, it is highly likely that a sidelink communication in the partial coverage in which the UE 1 operates as a relay UE occurs. Applying the condition (a), it is possible to provide a special treatment to a sidelink communication in the partial coverage.

Regarding the condition (b), the UE 1 may transmit the sidelink resource information when the UE 2 is out of coverage of the E-UTRAN 3. Regarding the condition (c), the UE 1 may transmit the sidelink resource information when the UE 2 cannot be connected to the E-URAN 3. It can also be said that the conditions (b) and (c) are conditions regarding whether the communication to be performed is a sidelink communication in the partial coverage. Applying the condition (b) or (c), it is possible to provide a special treatment to a sidelink communication in the partial coverage.

Regarding the condition (d), the UE 1 may transmit the sidelink resource information when the UE 1 is transmitting the synchronization signal (e.g., Sidelink Synchronization Signal). In some implementations, the UE 1 may transmit the synchronization signal to be detected by the remote UE 2 (e.g., Sidelink Synchronization Signal) autonomously or in response to an instruction from the PLMN 100 (e.g., eNodeB 31) when the UE 1 is located in the vicinity of the coverage boundary of the E-UTRAN 3 (the edge of the cell 32). In some implementations, the relay UE 1 may autonomously transmit the synchronization signal when the reception quality (e.g., RSRP or RSRQ) of the radio signal transmitted from the eNodeB 31 is below a threshold. In some implementations, the PLMN 100 (e.g., eNodeB 31) may specify a relay UE 1 which is located in the vicinity of the cell edge and instruct this UE to transmit the synchronization signal. In some implementations, the PLMN 100 (e.g., eNodeB 31) may instruct the UE 1 which is located in the vicinity of the cell edge of the cell 32 to transmit the synchronization signal when the PLMN 100 (e.g., eNodeB 31) receives from the UE 2 a report (e.g., RRC measurement report) indicating that it is about to be out of coverage. Applying the condition (d), it is possible to provide a special treatment to a sidelink communication in the partial coverage.

Regarding the condition (e), the UE 1 may transmit the sidelink resource information when the UE 1 has been instructed by the E UTRAN 3 (e.g., the eNodeB 31) to transmit the sidelink resource information.

Regarding the condition (f), the UE 1 may transmit the sidelink resource information when it initiates sidelink communication with the UE 2. Further, the sidelink resource information may be transmitted from the UE 1 to the UE 2, from the UE 2 to the UE 1, or bidirectionally. The UEs 1 and 2 may perform sidelink communication using the first radio resource that relates to the sidelink resource information for the effective period or effective number of times.

### Second Embodiment

This embodiment provides a modified example of the control procedure regarding the sidelink communication described in the first embodiment. The configuration example of a public land mobile network according to this embodiment is the same as that shown in FIGS. 1 to 4.

FIG. 6 is a flowchart showing one example (Process 600) of operations of the eNodeB 31 according to this embodiment. In Block 601, the eNodeB 31 receives the sidelink resource information from the UE 1. In Block 602, the eNodeB 31 performs uplink (UL) scheduling in the cell 32 while talking into account the sidelink resource information. For example, the eNodeB 31 may avoid allocation of the first radio resource, which is used in sidelink communication between the UEs 1 and 2, to an uplink transmission from the UE 1 to the eNodeB 31. Further or alternatively, the eNodeB 31 may avoid allocation of the first radio resource, which is used in sidelink communication between the UEs 1 and 2, to an uplink transmission of a UE other than the UEs 1 and 2.

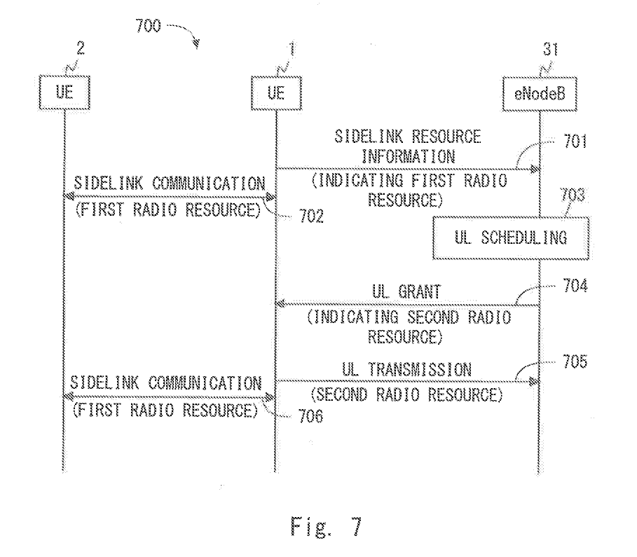

With reference to FIG. 7, an example in which the sidelink resource information received from the UE 1 is taken into account at the time of UL scheduling of the UE 1 will be described. FIG. 7 is a sequence diagram showing one example (Process 700) of the control procedure regarding the sidelink communication according to this embodiment. In Block 701, the UE 1 transmits the sidelink resource information to the eNodeB 31. This sidelink resource information indicates the first radio resource to be used for the sidelink communication between the UEs 1 and 2 (Blocks 702 and 706), the effective period or effective number of times of the first radio resource, or both of them.

In Block 703, the eNodeB 3 1 schedules an UL transmission of the UE 1 while taking into account the sidelink resource information. Specifically, the eNodeB 31 allocates, to the uplink transmission of the UE 1, a radio resource (i.e., second radio resource) that is different from the first radio resource indicated by the sidelink resource information. In Block 704, the eNodeB 31 transmits to the UE 1 a scheduling grant (UL grant) indicating that UL transmission is permitted. This UL grant indicates the second radio resource. In Block 705, the UE 1 performs UL transmission using the second radio resource in accordance with the UL grant. Since the radio resources to be used are different from each other, the UE 1 may simultaneously perform the uplink transmission (Block 705) and the sidelink communication (Block 706).

As can be understood from the foregoing description, the eNodeB 31 according to this embodiment is configured to perform uplink scheduling for the UE 1 or another UE while talking into account the sidelink resource information received from the UE 1. Accordingly, the eNodeB 31 can contribute to suppression of resource conflicts or interferences between a sidelink communication of the UE 1 and uplink transmissions in the cell 32.

### Third Embodiment

This embodiment provides a modified example of the control procedure regarding the sidelink communication described in the first embodiment. The configuration example of a public land mobile network according to this embodiment is the same as that shown in FIGS. 1 to 4.

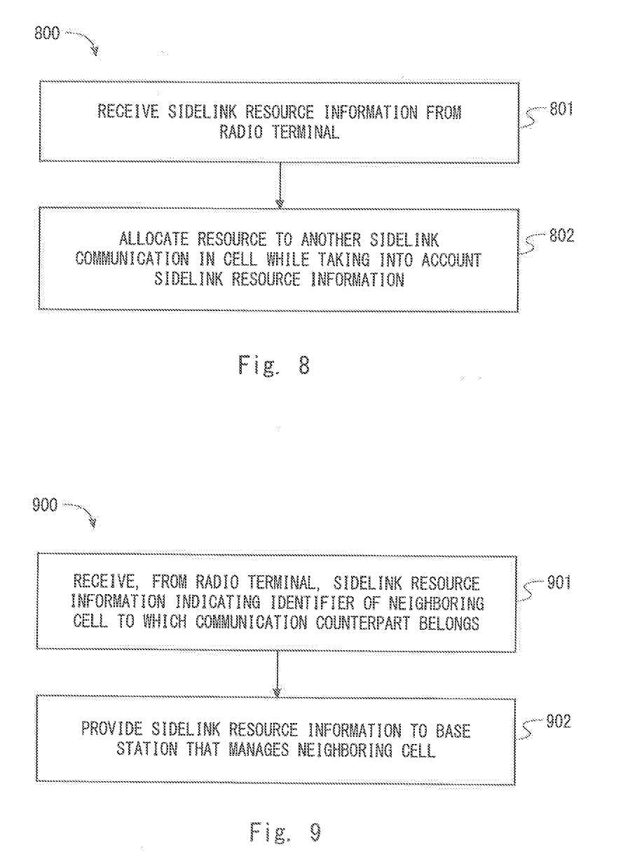

FIG. 8 is a flowchart showing one example (Process 800) of operations of the eNodeB 31 according to this embodiment. In Block 801, the eNodeB 31 receives the sidelink resource information from the UE 1. In Block 802, the eNodeB 31 allocates a resource to another sidelink communication in the cell 32 while talking into account the sidelink resource information. For example, the eNodeB 31 may change the resource pool(s) for the other sidelink communication in the cell 32 so as to exclude the first radio resource from this resource pool. The other sidelink communication in the cell 32 may be a second sidelink communication performed by the UE 1 or a sidelink communication performed by a UE other than the UEs 1 and 2. These operations contribute to suppression of conflicts and interferences of radio resources between sidelink communications.

### Fourth Embodiment

This embodiment provides a modified example of the control procedure regarding the sidelink communication described in the first. The configuration example of the public land mobile network according to this embodiment is the same as that shown in FIGS. 1 to 4.

FIG. 9 is a flowchart showing one example (Process 900) of operations of the eNodeB 31 according to this embodiment, in Block 901, the eNodeB 31 receives the sidelink resource information from the UE 1. In a way similar to that in the descriptions in the above embodiments, the sidelink resource information indicates the first radio resource to be used for sidelink communication between the UEs 1 and 2.

Further, in this embodiment, the sidelink resource information includes an identifier (e.g., E-UTRAN Cell Global Identifier (ECGI) or E-UTRAN Cell Identifier (ECI)) of the neighboring cell to which the communication counterpart UE (i.e., UE 2) belongs. The sidelink resource information is simply required to include information to specify the cell to which the communication counterpart UE (i.e., UE 2) belongs or the eNodeB that manages this cell. Accordingly, the sidelink resource information may include an identifier of the neighboring eNodeB (e.g., Global eNodeB ID or eNodeB ID) in place of, or in combination with, the identifier of the neighboring cell. Further or alternatively, the sidelink resource information may include an identifier (e.g., SAE Temporary Mobile Subscriber Identity (S-TMSI), Globally Unique Temporary UE identity (GUTI), or an EPC-ProSe-User ID) of the communication counterpart UE (i.e., the UE 2), The eNodeB 3 1 may inquire an MME or a ProSe Function entity about the cell to which the communication counterpart UE (i.e., the UE 2) belongs or the eNodeB by using the identifier of the communication counterpart UE (i.e., UE 2).

In Block 902, the eNodeB 31 provides the sidelink resource information to the eNodeB that manages the neighboring cell to which the communication counterpart UE (i.e., UE 2) belongs.

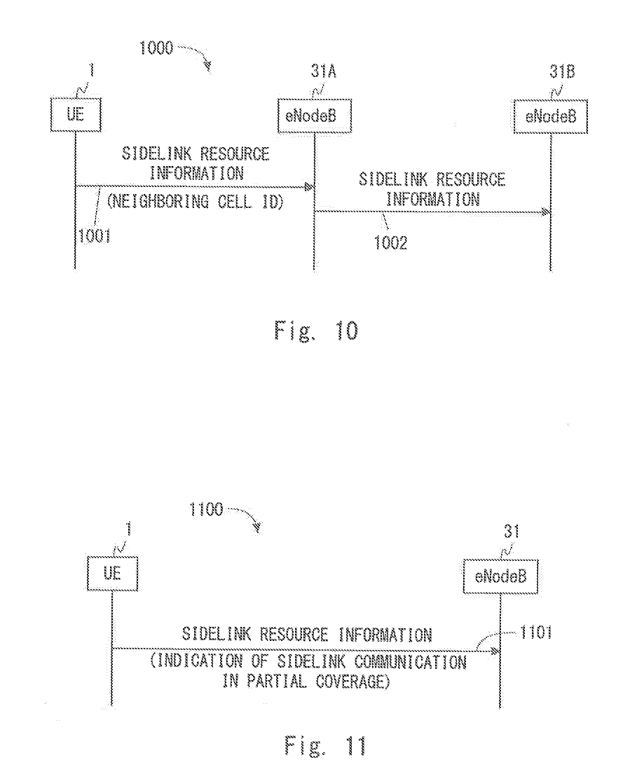

FIG. 10 is a sequence diagram showing one example (Process 1000) of the control procedure regarding the sidelink communication according to this embodiment. In Block 1001, the UE 1 transmits, to the serving eNodeB (i.e., eNodeB 31A) to which the UE 1 belongs, the sidelink resource information together with the identifier of the neighboring cell 32B to which the communication counterpart UE (i.e., the UE 2) belongs. The sidelink resource information indicates the first radio resource that is used in the sidelink communication between the UE 1 that belongs to the cell 32A and the UE 2 that belongs to the cell 32B (i.e., inter-cell (or inter-base station) sidelink communication). In Block 1002, the eNodeB 31A transmits this sidelink resource information to the neighboring eNodeB 31B that manages the neighboring cell 32B.

According to this embodiment, the neighboring eNodeB 31B can perform uplink scheduling in the neighboring cell 32B and allocation of radio resources to sidelink communication in the neighboring cell 32B, while taking into account the first radio resource used in inter-cell (or inter-base station) sidelink communication. Accordingly, it is possible to contribute to suppression of interference caused by the inter-cell sidelink communication to the uplink transmission or sidelink communication in the neighboring cell 32B. At the same time, it is possible to contribute to suppression of interference caused by the uplink transmission or sidelink communication in the neighboring cell 32B to the inter-cell sidelink communication.

### Fifth Embodiment

This embodiment is a modified example of the control procedure regarding the sidelink communication described in the first to fourth embodiments, in the following description, this embodiment will be described as a modified example of the first embodiment. The configuration example of the public land mobile network according to this embodiment is similar to that shown in FIGS. 1 to 4.

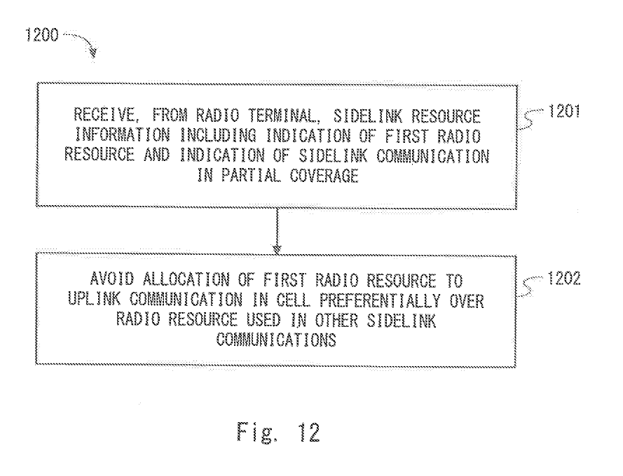

FIG. 11 is a sequence diagram showing one example (Process 1100) of the control procedure regarding the sidelink communication according to this embodiment. In Block 1101, the UE 1 transmits the sidelink resource information to the eNodeB 31. In a way similar to that in the descriptions in the other embodiments, the sidelink resource information indicates the first radio resource to be used for the sidelink communication between the UEs 1 and 2.

Further, in this embodiment, the sidelink resource information includes an indication indicating whether the sidelink communication to be performed is a sidelink communication in the partial coverage. In other words, the sidelink resource-information indicates whether the communication counterpart UE (i.e., UE 2) of the sidelink communication is out of coverage of the E-UTRAN 3, or whether the communication counterpart UE (i.e., UE 2) is a UE that cannot be connected to the E-UTRAN 3.

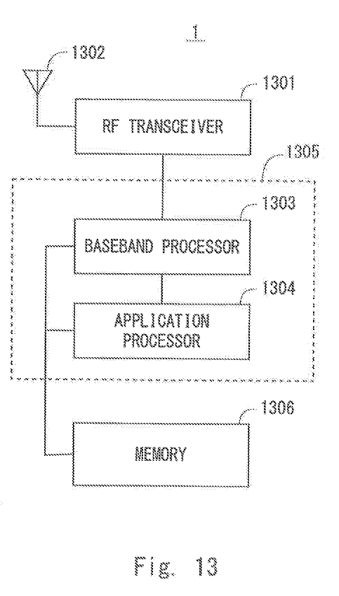

FIG. 12 is a flowchart showing one example (Process 1200) of operations of the eNodeB 31 according to this embodiment. In Block 1201, the eNodeB 31 receives the sidelink resource information from the UE 1. This sidelink resource information includes an indication of the first radio resource and an indication of the sidelink communication in the partial coverage. As already described above, this sidelink resource information may include, in place of or in combination with the indication of the first radio resource, an indication indicating the effective period or effective number of times of this first radio resource.

In Block 1202, the eNodeB 31 avoids allocation of the first radio resource to the uplink communication in the cell 31 preferentially over radio resources used in other sidelink communications (i.e., sidelink communication in the coverage). In other words, the eNodeB 31 may use the second radio resource, which is used in other sidelink communications (i.e., sidelink communication in the coverage), for uplink transmissions in the cell 32 preferentially over the first radio resource, which is used in the sidelink communication in the partial coverage. As one example, assume a case in which the UE 1 uses the first radio resource for the sidelink communication in the partial coverage with the UE 2 and the UE 1 uses the second radio resource for the sidelink communication in the coverage with another UE. In this case, the eNodeB 31 may allocate the second radio resource, without allocating the first radio resource, to the uplink transmission of the UE 1 in the cell 31.

As can be understood from the foregoing description, the UE 1 according to this embodiment is configured to transmit, to the serving eNodeB 31, the sidelink resource information including an indication indicating whether the sidelink communication to be performed is a sidelink communication in the partial coverage. Accordingly, the eNodeB 31 can distinguish the sidelink communication in the partial coverage from other sidelink communications when scheduling and allocating the radio resources. Accordingly, for example, the eNodeB 31 can provide a special treatment to a sidelink communication in the partial coverage when it performs scheduling and allocating of radio resources.

Lastly, configuration examples of the radio terminal (UE 1) and the base station (the eNodeB 31) according to the aforementioned embodiments will be described. The radio terminal (i.e., UE 1) described in the aforementioned embodiments may include a radio transceiver to communicate with a base station (e.g., eNodeB 31), and a controller coupled to this radio transceiver. The controller executes processing regarding the radio terminal (the UE 1) described in the aforementioned embodiments.

The base station (the eNodeB 31) described in the aforementioned embodiments may include a radio transceiver to communicate with radio terminals (e.g., UE 1), and a controller coupled to the radio transceiver. The controller executes processing regarding the base station (the eNodeB 31) described in the aforementioned embodiments.

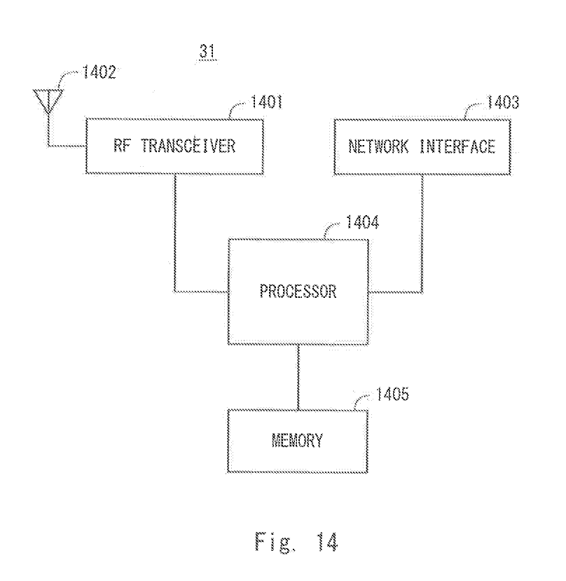

FIG. 13 is a block diagram showing a configuration example of the UE 1. A Radio Frequency (RF) transceiver 1301 performs analog RF signal processing to communicate with the eNodeB 31. The RF transceiver 1301 may further be used for the sidelink communication (Direct discovery and Direct communication) with another UE. The RF transceiver 1301 may include a first transceiver used for the communication with the eNodeB 31 and a second transceiver used for the sidelink communication with another UE. The analog RF signal processing performed by the RF transceiver 1301 includes frequency up-con version, frequency down-conversion, and amplification. The RF transceiver 1301 is coupled to an antenna 1302 and a baseband processor 1303. That is, the RF transceiver 1301 receives modulated symbol data (or OFDM symbol data) from the baseband processor 1303, generates a transmission RF signal, and supplies the transmission RF signal to the antenna 1302. Further, the RF transceiver 1301 generates a baseband reception signal based on a reception RF signal received by the antenna 1302 and supplies this signal to the baseband processor 1303.

The baseband processor 1303 performs digital baseband signal processing (i.e., data plane processing) and control plane processing for radio communication. The digital baseband signal processing includes (a) data compression/decompression, (b) data segmentation/concatenation, (c) composition/decomposition of a transmission format (i.e., transmission frame), (d) channel coding/decoding, (e) modulation (i.e., symbol mapping)/demodulation, and (f) generation of OFDM symbol data (i.e., baseband OFDM signal) by Inverse Fast Fourier Transform (IFFT). On the other hand, the control plane processing includes communication management of layer 1 (e.g., transmission power control), layer 2 (e.g., radio resource management and hybrid automatic repeat request (HARQ) processing), and layer 3 (e.g., signaling regarding attach, mobility, and call management).

For example, in the case of LTE and LTE-Advanced. the digital baseband signal processing performed by the baseband processor 1303 may include signal processing of a Packet Data Convergence Protocol (PDCP) layer, an RLC layer, a MAC layer, and a PHY layer. Further, the control plane processing performed by the baseband processor 1303 may include processing of a Non-Access Stratum (NAS) protocol and an RRC protocol.

The baseband processor 1303 may include a modem processor (e.g., a Digital Signal Processor (DSP)) that performs the digital baseband signal processing and a protocol stack processor (e.g., a Central Processing Unit (CPU) or a Micro Processing Unit (MPU)) that performs the control plane processing. In this case, the protocol stack processor, which performs the control plane processing, may be integrated with an application processor 1 304 described in the following.

The application processor 1304 may also be referred to as a CPU, an MPU, a microprocessor, or a processor core. The application processor 1304 may include a plurality of processors (processor cores). The application processor 1304 loads a system software program (Operating System (OS)) and various application programs (e.g., a voice call application, a WEB browser, a mailer, a camera operation application, and a music player application) from a memory 1306 or from another memory (not shown) and executes these programs, thereby providing various functions of the UE 1.

In some implementations, as represented by a dashed line (1305) in FIG. 13, the baseband processor 1303 and the application processor 1304 may be integrated on a single chip. In other words, the baseband processor 1303 and the application processor 1304 may be implemented in a single System on Chip (SoC) device 1305. A SoC device may be referred to as a system Large Scale Integration (LSI) or a chipset.

The memory 1306 is a volatile memory, a non-volatile memory, or a combination thereof. The memory 1306 may include a plurality of memory devices that are physically independent from each other. The volatile memory is, for example, a Static Random Access Memory (SRAM), a Dynamic RAM (DRAM), or a combination thereof. The non-volatile memory is, for example, a mask Read Only Memory (MROM), an Electrically Erasable Programmable ROM (EEPROM), a flash memory, a hard disc drive, or any combination thereof. The memory 1306 may include, for example, an external memory device that can be accessed by the baseband processor 1303, the application processor 1304, and the SoC 1305. The memory 1306 may include an internal memory device that is integrated in the baseband processor 1303, the application processor 1304, or the SoC 1305. Further, the memory 1306 may include a memory in a Universal Integrated Circuit Card (UICC).

The memory 1306 may store software module (computer program) including instructions and data to perform processing by the UE 1 described in the aforementioned embodiments. In some implementations, the baseband processor 1303 or the application processor 13 04 may be configured to load the software module from the memory 1306 and execute the loaded software module, thereby performing the processing of the UE 1 described in the aforementioned embodiments.

FIG. 14 is a block diagram showing a configuration example of the eNodeB 31 according to the aforementioned embodiments. With reference to FIG. 14, the eNodeB 31 includes an RF transceiver 1401, a network interface 1403, a processor 1404, and a memory 1405. The RF transceiver 1401 performs analog RF signal processing to communicate with the UE 1 and the UE 2. The RF transceiver 1401 may include a plurality of transceivers. The RF transceiver 1401 is coupled to an antenna 1402 and the processor 1404. The RF transceiver 1401 receives modulated symbol data (or OFDM symbol data) from the processor 1404, generates a transmission RF signal, and supplies the transmission RF signal to the antenna 1402. Further, the RF transceiver 1401 generates a baseband reception signal based on the reception RF signal received by the antenna 1402 and supplies this signal to the processor 1404.

The network interface 1403 is used to communicate with a network node(s) (e.g., other eNodeBs, MME, and S/P-GW). The network interface 1403 may include, for example, a network interface card (NIC) conforming to the IEEE 802.3 series.

The processor 1404 performs digital baseband signal processing (data plane processing) and control plane processing for radio communication. For example, in the case of LTE and LTE-Advanced, the digital baseband signal processing performed by the processor 1404 may include signal processing of the PDCP layer, the RLC layer, the MAC layer, and the PHY layer. Further, the control plane processing performed by the processor 1404 may include processing of the Si protocol and the RRC protocol.

The processor 1404 may include a plurality of processors. The processor 1404 may include, for example, a modern processor (e.g., DSP) that performs the digital baseband signal processing and a protocol stack processor (e.g., CPU or MPU) that performs the control plane processing,

The memory 1405 is composed of a combination of a volatile memory and a non-volatile memory. The volatile memory is, for example, an SRAM, a DRAM, or a combination thereof. The non-volatile memory is, for example, an MROM, a PROM, a flash memory, a hard disc drive, or a combination thereof. The memory 1405 may include a storage located apart from the processor 1404. In this case, the processor 1404 may access the memory 1405 via the network interface 1403 or an I/O interface (not shown).

The memory 1405 may store a software module (computer program) including instructions and data to perform processing by the eNodeB 31 described in the aforementioned embodiments, in some implementations, the processor 1404 may be configured to load the software module from the memory 1405 and execute the loaded software module, thereby performing processing of the eNodeB 31 described in the aforementioned embodiments.

As described above with reference to FIGS. 13 and 14, each of the processors included in the UE 1 and the eNodeB 31 according to the aforementioned embodiments executes one or a plurality of programs including instructions to cause a computer to perform the algorithm(s) described with reference to the drawings. The program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### Other Embodiments

Each of the above-described embodiments may be used individually, or two or more of the embodiments may be appropriately combined with one another.

In the aforementioned embodiments, the ease in which the radio resource to be used for the sidelink communication is selected from the subset of the uplink radio resources has been mainly described. However, the aforementioned embodiments may be applied to a case in which the radio resource to be used for the sidelink communication is selected from a subset of downlink radio resources.

In this case, when the eNodeB 31 performs downlink scheduling, it may take into account the sidelink resource information which it as been sent from the UE 1. This information indicates the first radio resource to be used for sidelink communication, the effective period or effective number of times of the first radio resource, or both of them. For example, the eNodeB 31 may avoid allocation of the first radio resource to downlink transmission to the UE 1. Further or alternatively, when the sidelink communication to which the first radio resource is allocated is the sidelink communication in the partial coverage, the eNodeB 31 may avoid allocation of the first radio resource to downlink transmission in the cell 32 preferentially over the second radio resource that is used in other sidelink communications (i.e., the sidelink communication in the coverage). In other words, the eNodeB 31 may use the second radio resource, which is allocated to other sidelink communications (i.e., the sidelink communication in the coverage), for the downlink transmission in the cell 32 preferentially over the first radio resource, which is allocated to the sidelink communication in the partial coverage.

In the aforementioned embodiments, the explanation has been given mainly using the specific examples with regard to the EPS. However, these embodiments may be applied to other mobile communication systems such as a Universal Mobile Telecommunications System (UMTS), a 3GPP2 CDMA2000 system (1xRTT, High Rate Packet Data (HRPD)), a Global System for Mobile communications (GSM)/General packet radio service (GPRS) system, and a mobile WiMAX system. In this case, the processes or the procedures regarding the sidelink communication performed by the eNodeB 31 described in the aforementioned embodiments may be performed by an entity that is located in the radio access network and controls radio resources in a cell (e.g., a Radio Network Controller (RNC) in a UMTS or a Base Station Controller (BSC) in a GSM system).

Further, the embodiments described above are merely examples of applications of the technical ideas obtained by the present inventors, Needless to say, these technical ideas are not limited to the above-described embodiments and various modifications can be made thereto.

This application is based upon and claims the benefit of priority from Japanese Patent Application No. 2015-055596, filed on Mar. 19, 2015, the disclosure of which is incorporated herein in its entirety by reference.

### Reference Signs List

1 User Equipment (UE)
2 UE
3 Evolved Universal Terrestrial Radio Access Network (E-UTRAN)
4 Evolved Packet Core (EPC)
5 Proximity-based Services (ProSe) FUNCTION ENTITY
6 ProSe APPLICATION SERVER
31 Evolved NodeB (eNodeB)
32 CELL
100 Public Land Mobile Network (PLMN)
102 INTER-UE DIRECT INTERFACE (SIDELINK)

1. A radio terminal apparatus comprising:
at least one radio transceiver; and
at least one processor coupled to the at least one radio transceiver, wherein
the at least one processor is configured to transmit resource information to a radio access network, the resource information indicating a first radio resource to be used for sidelink communication, an effective period or effective number of times of the first radio resource, or both the first radio resource and the effective period or effective number of times, and
the sidelink communication comprises at least one of direct discovery and direct communication performed between the radio terminal apparatus and another radio terminal using the at least one radio transceiver.

2. The radio terminal apparatus according to claim 1, wherein
radio resources to be used for the sidelink communication is limited to a subset of a plurality of radio resources reserved for uplink transmissions or downlink transmissions between the radio access network and a plurality of radio terminals including the radio terminal apparatus, and
the first radio resource is contained in the subset.

3. The radio terminal apparatus according to claim 1, wherein the at least one processor is configured to select the first radio resource from a resource pool which is allocated by the radio access network or from a resource pool pre-configured in the radio terminal apparatus.

4. The radio terminal apparatus according to claim 1, wherein
the at least one processor is configured, when a predetermined condition is satisfied, to transmit the resource information to the radio access network, and
the predetermined condition comprises at least one of (a) a condition regarding whether the radio terminal apparatus is located in a vicinity of a coverage boundary of the radio access network, (b) a condition regarding whether the other radio terminal is out of coverage of the radio access network, (c) a condition regarding whether the other radio terminal can be connected to the radio access network, (d) a condition regarding whether the radio terminal apparatus is transmitting a synchronization signal to be detected by the other radio terminal, (e) a condition regarding whether the radio terminal apparatus has been instructed by the radio access network to transmit the resource information, and (f) a condition regarding whether the radio terminal apparatus performs the sidelink communication with the other radio terminal.

5. The radio terminal apparatus according to claim 1, wherein the first radio resource comprises at least one of a time slot, a carrier frequency, a time-frequency resource element, a subframe, and transmission power.

6. The radio terminal apparatus according to claim 1, wherein the at least one processor is further configured to transmit, to the radio access network, information indicating whether the sidelink communication is performed with a radio terminal which is out of coverage of the radio access network or a radio terminal that cannot be connected to the radio access network.

7. The radio terminal apparatus according to claim 1, wherein the at least one processor is further configured to transmit, to the radio access network, at least one of an identifier of the other radio terminal, an identifier of a cell to which the other radio terminal belongs, and an identifier of a base station that manages the cell.

8. The radio terminal apparatus according to claim 1, wherein the at least one processor is configured to transmit the resource information to a radio resource control node in the radio access network.

9. The radio terminal apparatus according to claim 1, herein the at least one processor is further configured to notify the other radio terminal of the resource information.

10. (canceled)

11. An entity that is located in a radio access network and controls radio resources in a cell, the entity comprising:
a memory; and
at least one processor coupled to the memory, wherein
the at least one processor is configured to receive resource information from a first radio terminal, the resource information indicating a first radio resource to be used for sidelink communication, an effective period or effective number of times of the first radio resource, or both the first radio resource and the effective period or effective number of times, and
the sidelink communication comprises at least one of direct discovery and direct communication performed between the first radio terminal and a second radio terminal.

12. The entity according to claim 11, wherein
radio resources to be used for the sidelink communication is limited to a subset of a plurality of radio resources reserved for uplink transmissions or downlink transmissions among the radio resources in the cell, and
the first radio resource is contained in the subset.

13. The entity a according to claim 11, wherein the first radio resource is selected from a resource pool which is allocated by the radio access network or from a resource pool pre-configured in the first radio terminal.

14. The entity according to claim 11, wherein the first radio resource comprises at least one of a time slot, a carrier frequency, a time-frequency resource element, a subframe, and transmission power.

15. The entity according to claim 11, wherein the at least one processor is configured to take into account the resource information when performing resource scheduling in the cell.

16. The entity according to claim 15, wherein the at least one processor is configured to avoid allocation of the first radio resource to an uplink transmission from the first radio terminal to the radio access network or a downlink transmission from the radio access network to the first radio terminal.

17. The entity according to claim 15, wherein the at least one processor is configured, when the second radio terminal is a radio terminal which is out of coverage of the radio access network or is a radio terminal that cannot be connected to the radio access network, to allocate a second radio resource, which is used in another sidelink communication, to an uplink transmission or a downlink transmission in the cell preferentially over the first radio resource.

18. The entity according to claim 11, wherein the at least one processor is configured to take into account the resource information when determining one or a plurality of radio resources to be allocated to another sidelink communication performed in the cell.

19. The entity according to claim 11, wherein the at least one processor is configured to provide the resource information to another entity that controls radio resources in a neighboring cell.

20. The entity according to claim 11, wherein the at least one processor is further configured to receive, from the first radio terminal, information indicating whether the sidelink communication is performed with a radio terminal which is out of coverage of the radio access network or a radio terminal that cannot be connected to the radio access network.

21-28. (canceled)

29. A method performed by an entity that is located in a radio access network and controls radio resources in a cell, the method comprising:
receiving resource information from a first radio terminal, the resource information indicating a first radio resource to be used for sidelink communication, an effective period or effective number of times of the first radio resource, or both the first radio resource and the effective period or effective number of times, wherein
the sidelink communication comprises at least one of direct discovery and direct communication performed between the first radio terminal and a second radio terminal.

30-39. (canceled)
